(19) United States
(12) Patent Application Publication
(10) Pub. No.: US 2021/0139103 A1
(43) Pub. Date: May 13, 2021

(54) AUTONOMOUS BICYCLE SYSTEM

(71) Applicant: Carla R. Gillett, Sacramento, CA (US)

(72) Inventor: Carla R. Gillett, Sacramento, CA (US)

(73) Assignee: Carla R. Gillett, Sacramento, CA (US)

(21) Appl. No.: 17/145,275

(22) Filed: Jan. 8, 2021

Related U.S. Application Data
(63) Continuation-in-part of application No. 16/370,981, filed on Mar. 30, 2019.

(51) Int. Cl. B62M 6/50; B62M 6/90; B62J 45/41; B62J 45/20; G05D 1/00; G05D 1/02; B62K 11/00; B62K 23/02; B62H 1/02; B62J 50/22; G01C 21/36; G06Q 30/06

(52) U.S. Cl. CPC B62M 6/50; B62M 6/90; B62J 45/41; B62J 45/20; G05D 1/0061; G05D 1/0278; G06Q 10/08355; B62K 23/02; B62H 1/02; B62J 50/22; G05D 1/0212; G01C 21/3691; G06Q 30/0645; B62K 11/007

(57) ABSTRACT

Disclosed is an autonomous bicycle system including a navigation system, a steering system, a pedal assist system providing extra propulsion when engaged, and provides a combination of internal and external sensors, cameras for detecting threats and obstacles in an environment. Respectively the autonomous bicycle can be controlled manually or controlled remotely by a control network alternatively in real-time to switch from a manual driving state to an autonomous driving state or vice versa in respect to mechanical motion involving steering, velocity and position and maintaining balance support of autonomous bicycle when in motion or when stationary. A control network providing a virtual operator systematically controlling a current position of the autonomous bicycle in real-time based on at least one rider-selected starting location and destination location, and a smartphone connected therein providing an APP linking the rider to use the autonomous bicycle for various rider plans, control network plans or service plans.

A notice of issuance for a continuation in part of in reference to patent application Ser. No. 16/370,981, filing date: Mar. 30, 2019, titled Autonomous Bicycle.

### TECHNICAL FIELD

This disclosure relates generally to autonomous techniques for autonomous bicycles used in ride sharing services, use for delivery services, and use a remote network system to control the autonomous bicycle with or without a rider present.

### BACKGROUND

Motorized autonomous bicycles and other autonomous bicycle form factors with less than four wheels are widely used around the globe. These autonomous bicycle form factors often rely on a user to keep the autonomous bicycle upright during operation. As a result of heavy reliance on a rider for balance and for steering control, these autonomous bicycles are typically excluded from techniques applied to general autonomous bicycles. For example, these general autonomous bicycles operate without considering a need for remote network system to control the autonomous bicycle with or without a rider present.

### SUMMARY

The present autonomous bicycle system offers an autonomous bicycle configured for accomplishing at least one function involving a rider plan, a control network plan, a service plan or a combination thereof and offers an autonomous bicycle operating with or without a rider onboard. Respectively the autonomous bicycle operates by manual control, operates remotely by a control network or operated with a combination of both to control steering directions, balance, and propulsion of the autonomous bicycle via an autonomous control system which is configured to switch from a manual driving to an autonomous driving, or vice versa when indicative of a rider's plan, a control network plan or a service plan which may involve rental or delivery services.

### BRIEF DESCRIPTION OF THE DRAWINGS

One or more preferred exemplary embodiments of the invention will hereinafter be described in conjunction with the appended drawings, wherein like designations denote like elements.

FIG. 1 is a side view illustrating a configuration of an autonomous bicycle 100 in accordance with exemplary embodiments of the present invention.

FIG. 1A, FIG. 1B and FIG. 1C are is illustrations electronic components of the autonomous bicycle 100 in FIG. 1 in accordance with exemplary embodiments of the present invention.

FIG. 2 is a flowchart illustrating an operation of the autonomous bicycle system 200 in accordance with exemplary embodiments of the present invention.

FIG. 3A is a flowchart illustrating an operation of the control network 300 in accordance with exemplary embodiments of the present invention.

FIG. 3B is a graph illustrating a threshold value for switching to manual driving 304, which changes stepwise with respect to a distance to an obstacle in accordance with exemplary embodiments of the present invention.

FIG. 4 is a graph illustrating the threshold value for switching to manual driving 304, which linearly changes with respect to the distance to the obstacle in accordance with exemplary embodiments of the present invention.

FIG. 5 is a graph illustrating the threshold value for switching to manual driving 304 with respect to the distance to the obstacle and a type of the obstacle in accordance with exemplary embodiments of the present invention.

FIG. 6 is a flowchart of a method of operating a telematics unit 600 in accordance with exemplary embodiments of the present invention.

### DETAILED DESCRIPTION OF THE DRAWINGS

The present disclosure provides various modes of transportation which can operate with a system such as the present invention, the following elements can be applied to accommodate driving systems of electric vehicles like, bicycles or tricycles utilizing a motorized chain driven system that turns a rear wheel which allows the autonomous bicycle or other electric bike to travel in an operating environment and the autonomous bicycle system is configured for generating communication information and data and transmitting a command that controls at least one function of the autonomous bicycle based on one of; a rider plan, a control network plan, a service plan or a combination thereof.

In greater detail FIG. 1 is an embodiment of the autonomous bicycle system providing a mode of transportation characterized as an autonomous bicycle 100 having a frame 1, a seat 2 provided for supporting the rider 101, a front wheel 3 having an electronic motor 3a attached to the lower end of the front fork 3b and a rear wheel 4 connected to rear hub 4a and rotatably attached to an automated pedal assistance system 10, a steering column 5 connected to a handlebar 5a for changing the direction of the front wheel 3 via a rider 101, a steering actuator 6 for changing the steering angle of the front wheel 3, a throttle controller 7, a brake controller 8, controllers 9 connecting to the electronic motors, a common kickstand 12a and/or an electro-mechanical kickstand 12b, an electrical system 13 linked to a battery system 14 and to a control panel 21 comprising a virtual display 21a for rider interface 101(I), storage 16 provided by a compartment saddlebags, baskets or insulated containers, and a control unit 209 linked to a combination of sensors involving LIDAR, radar, GPS, electronic components 210 like Gyros 210a, IMU 210b, hardware 210c, a control panel 21, and the like controlled by systems 200-300 detailed in FIG. 2 and FIG. 3.

In various elements a throttle controller 7 and a brake controller 8 that is attached to the handlebar 5a of the steering column 5 and both handles can be operated by a rider 101, or an alternative is possible in which the throttle controller 7 and the brake controller 8 are systematically controller by an onboard navigation system 205 or remotely through a control network 300 300. Wherein the throttle controlling connecting to at least one electronic motor, the brake controller 5b connecting to at least one wheel.

The autonomous bicycle system elements 200-300 may include a control panel 21 may be situated between the handlebar 5a in view of the rider 101. Accordingly, the steering column 5 and handlebar 5a are to manually steer the autonomous bicycle 101 during manual driving 304.

Accordingly, the control panel provides rider interface via a virtual a touch screen configured with a menu of control settings, performance status of autonomous bicycle then storing performance data to memory in Cloud. Accordingly, the rider provides wireless instruction via a smartphone connected therein providing Internet, WIFI, Bluetooth and mobile APPs. Wherein an APP having programming systematically receives rider input in accordance with linked information received from sensor data to manually navigate the autonomous bicycle to selected geographic areas. In various aspects a rider's plan 101(RP) uses manual driving 304 force 101(F) or uses the automated pedal assistance system 10. Respectively when manual driving 304 force 101(F) is selected the rider 101 is to generate pedaling torque to rotate a set of pedals 11 accordingly pedaling torque rotates the rear wheel 4. Respectively when the rider 101 uses automated pedal assistance system 10 is to rotate the rear wheel 4.

The manual driving 304 force 101(F) involves the rider 101 to pedal causing rotational driving force to be transmitted to the rear wheel 4 via a sprocket 10b (so-called rear wheel gear) which the sprocket 10b causes a chain 10e connected to the rear wheel 4 attached to a hub 4a (also referred to as a rear hub) of the rear wheel 4) to rotate thus producing controlled manual driving 304 force 101(F).

As shown in FIG. 1A an electric propulsion system may be configured with a belt or chain connecting to a rear wheel; the present system operates with automated pedal assistance system 10 which uses an electronic motor 10d to rotate the front sprocket 10a and a rear sprocket 10b, accordingly when torque is applied by the electronic motor 10d, as the set of pedals 11 rotate about the crankshaft 10c even as the rider 101 pedals, electronic motor force is being transmitted to the rear wheel 4, thus producing an assist driving force 10(ADF).

In various elements the automated pedal assistance system 10 links to the control unit 209 which regulates battery power 14(BP) to the electronic motor 10d, accordingly the electronic motor 10d rotates integrally with a crankshaft 10c (so-called crank gear) therein producing an endless driving force transmission body such that this rotational driving force is transmitted through the chain 10e output connected to a sprocket 10b (so-called rear wheel gear) which causes the rear wheel 4 attached to a hub 4a (also referred to as a rear hub) of the rear wheel 4), the chain 10e is protected by a chain cover 10f.

Alternatively, the braking process may use a rim brake that presses a brake shoe that operates by operating a brake lever against a rim of a front wheel, a band brake of a rear wheel, a roller brake, or a coaster brake may be provided on the rear hub 4a to be braked by manually rotating the set of pedals 11 in the direction opposite to the rotation direction during forward traveling when activated by the rider 101.

In various elements the control unit 209 and battery system 14 manage the battery charging arrangement 14(BC) to receive an electrical connection from an external power source, the battery charging arrangement 14(BC) to charge batteries 14a of the battery system 14, and wherein the battery system 14 to provide regulated battery power 14(BP) to system elements 200-300 which may include lithium batteries 14a, or may include a battery and a secondary battery which are removeable, preferably. Wherein the electrical system 13 and wiring 13a connecting the battery system 14 to all electrical components.

Alternatively, another example of the battery charging element can use a capacitor which may involve batteries charged by a battery charging arrangement 14(BC) whereby a first battery 14b or a secondary battery to be charged 14c, or use the automated pedal assistance system to produce additional driving force 10(ADF) or propulsion) providing artificial pedaling resistance for regenerative braking 14(RB) associated with maintaining a battery power supply.

In various elements the common kickstand 12a can be manually activated by the rider 101 when parked.

In various elements an electro-mechanical kickstand 12b can be autonomously activated by the control unit 209 to maintain an upright position during autonomous driving 306, respectively the electro-mechanical kickstand 12b maintains the vertical axis of the front wheel 3 and rear wheel 4 with respect to keeping the autonomous bicycle 100 upright.

In various elements the electro-mechanical kickstand 12b may be configured with actuating motors to raise and lower during manual driving 304.

As shown in FIG. 1B the electro-mechanical kickstand 12b may be configured with dummy rear wheels 4a/4b for added balance support during autonomous driving 306, accordingly the electro-mechanical kickstand with dummy wheels is to be lowered at ground level when the autonomous bicycle 100 is unmanned such that balance is upheld when traveling or when no movement occurs.

In various elements the controllers 9 or “motor controllers” furnish regulated battery power to the electronic motors of the front wheel, the steering actuator 6 and the automated pedal assistance system 10. The regulated battery power 14(BP) provided through an electrical connection 13a linked to the control unit 209.

In various elements a combination of sensors 17-20 are required to detect mechanical motion, or to provide feedback from sensor input for monitoring movement based on the action of the rider whilst riding, wherein the autonomous bicycle's control unit 209 is configured to determine the current position of the autonomous bicycle based on the action of the rider whilst riding.

The internal sensors 17-20 are configured to detect information corresponding to a travelling state of the autonomous bicycle 100 and the amount of operation of any of the steering operation, the acceleration operation and the braking operation of the autonomous bicycle 100. In order to detect the information corresponding to the travelling state of the autonomous bicycle 100, the internal sensor includes at least one of electronic motor sensor 17, a steering actuator sensor 18, a throttle controller sensor 19 and a brake controller sensor 20 for example, the electronic motor sensor 17 is provided on the front wheel 3 or the rear wheel 4 rotated by the pedal assist electronic motor 10d. The electronic motor sensor 17 provide the speed information (wheel speed information) including the speed of the autonomous bicycle 100. The steering actuator sensor 18 placed on the steering actuator 6 is a detection device configured to detect steering operation with respect to changing yaw directions. The amount of operation detected by the steering sensor for example, a steering angle of a steering column 5 when turning by the steering actuator 6.

The throttle controller sensor 19 is a detection device configured to detect, for example, an amount of depression of the throttle controller sensor 19. The amount of depression of the throttle controller 7 is a position (hand position) of the throttle controller 7 with a predetermined position as a reference, for example. The predetermined position may be a fixed position or may be a position that is changed by predetermined parameters. The throttle controller sensor 19 may be provided, for example, on the hub of the wheel. The throttle controller sensor 19 provides outputs operation information corresponding to the amount of depression to the throttle controller 7 to the velocity autonomous bicycle 100.

The brake controller sensor 20 is a detection device configured to detect, for example, an amount of depression of the brake controller 8. The amount of depression of the brake controller 8 is a position (to apply pressure to the wheel rim or tire surface, or other predetermined position as a reference, for example. The predetermined position may be a fixed position or may be a position that is changed by predetermined parameters. The brake controller sensor 20 is provided, for example, on the handle portion of the brake controller sensor 20 may be provided. The brake controller sensor may detect an operation force (taking into account a depression force on the brake controller 8 or a pressure from the rider's hand when gripping). The brake controller sensor 20 may provide outputs the operation information corresponding to the amount of depression or the operation force on the brake controller to the front wheel 3 and rear wheel 4 of the autonomous bicycle 100.

As shown in FIG. 1C the control panel is situated between the handlebars of the steering column for example, a control panel 21 includes a display panel for displaying the image information for the rider, and the control panel 21 contains a speaker for audio output, and an operation button or a touch panel for the rider 101 to perform the input operation.

In various elements a riders plan 101(RP) involves providing rider plan 101(I) wherein the rider 101 may wirelessly link the autonomous bicycle's controller to her or his mobile phone, via Wi-Fi, Bluetooth or use a preferred APP to interface with the autonomous bicycle's controller such that the rider 101 can communicate remotely or control the autonomous bicycle system remotely via her or his smartphone 602 to generate GPS routes for the rider of the autonomous bicycle based on a rider-selected starting location and based on a rider-selected destination location based on the action of the rider whilst riding. The following paragraphs disclose the autonomous bicycle system 200 configured with combinations of external sensors 201, cameras 202, and GPS 203 all linked to a navigation system 205 indicative of a rider's plan during manual navigation or indictive of indicative of an autonomous navigation indicative of a control network 300, accordingly the navigation system processes associated with controlling steering, velocity, balance and position of an autonomous bicycle.

In greater detail FIG. 2 is a diagram of the autonomous bicycle system 200 configured for accomplishing at least one function involving a rider plan, a control network plan, a service plan or a combination thereof and offers an autonomous bicycle operating with or without a rider onboard. Respectively the autonomous bicycle operates by manual control, operates remotely by a control network or operated with a combination of both to control steering directions, balance, and propulsion of the autonomous bicycle via an autonomous control system 201 which is configured to switch from a manual driving 304 to an autonomous driving 306, or vice versa when indicative of a rider's plan 101(RP) accordingly when the autonomous bicycle is manned or when the autonomous bicycle is unmanned. Respectively the navigation system 205 is systematically linked via the control unit 209 to a stabilization system which receives data signals from the gyros sensors and/or IMU sensors monitoring balance states of the autonomous bicycle. Respectively the navigation system 205 is systematically linked via the control unit 209 to a steering system which receives data signals from the steering actuator sensor automated pedal assistance system 10 including a set of a set of pedals 11 and an electronic motor 10d coupled to a rear wheel 4f or providing extra propulsion when activating by a rider providing manual pedaling power or not providing manual pedaling power.

The autonomous bicycle system 200 utilizes the control network 300 configured to implement an autonomous driving 306 state indicative of a rider's plan 101(P) or indicative of a control network plan 208 executed by a virtual operator in real-time, wherein the control network 300 is in contact with the autonomous bicycle when the rider is presently onboard or when the rider is not presently onboard. The control network 300 generates a control network plan 208 with respect to feedback of external sensors including LIIDAR 201a and/or radar 201b which detect threats and obstacles in an environment of the autonomous bicycle during manual navigation or during autonomous navigation, the navigation system associated with determining GPS routes based on a control network plan 208.

The control unit 209 outputs a control signal corresponding to the control network plan 208 to the control unit 209, in this way, the control unit 209 controls the travelling of the autonomous bicycle 100 such that the autonomous driving 306 can be executed according to the control network plan 208. In addition, when the amount of operation acquired by the operation amount acquisition unit is equal to or greater than the threshold value for switching to manual driving 304 calculated by the calculation unit step, the control unit 209 can switch the driving state from autonomous driving 306 to manual driving 304 which is detailed in FIG. 3A.

For example, the communication path of autonomous bicycle 100 can include wireless rider interface within, optical communication, ultrasonic communication, or the combination thereof. For example, satellite communication 605, cellular communication, Bluetooth connecting with the user terminal via Wi-Fi or Bluetooth RTM, Infrared Data Association standard (IrDA), wireless fidelity (Wi-Fi), and worldwide interoperability for microwave access (WiMAX) are examples of wireless communication that can be included in the communication path. Cable, Ethernet, digital subscriber line (DSL), fiber optic lines, fiber to the home (FTTH), and plain old telephone service (POTS) are examples of wired communication that can be included in the communication path. Further, the communication path can traverse a number of control network 300 topologies and distances. For example, a communication path can include direct connection, personal area network (PAN), local area network (LAN), metropolitan area network (MAN), wide area network (WAN), or a combination thereof. The control system 101 can further execute software programming to include interaction with the communication path the connect rider interface 101(1) with a virtual operator 301 at the control network 300.

For example, the navigation system 205 utilizes detection devices configured to detect an external situation which is peripheral information of the autonomous bicycle 100 in which LIDAR 201a detects the obstacle outside the autonomous bicycle 100 using light. The LIDAR 201a transmits the light to the surroundings of the autonomous bicycle 100, measures the distance to the reflection point by receiving the light reflected from the obstacle, and then, detects the obstacle. The LIDAR 201a can output, for example, the distance or direction to the obstacle as the obstacle information of the obstacle. The LIDAR 201a outputs the detected obstacle information to the autonomous bicycle 100.

For example, the navigation system 205 utilizes detection devices configured to detect an external situation which is peripheral information of the autonomous bicycle 100 radar 201b detects an obstacle outside of the autonomous bicycle 100 using a radio wave. The radio wave is, for example, a millimeter wave. The radar 201b detects the obstacle by transmitting the radio wave to the surroundings of the autonomous bicycle 100 and receiving the wave reflected from the obstacle. The radar outputs, for example, the distance or direction to the obstacle as obstacle information of the obstacle. The radar outputs detected obstacle information to the autonomous bicycle 100. In a case of performing sensor fusion, the received information on the reflected radio wave may be output to the autonomous bicycle 100.

In a case of performing sensor fusion, the received information on the reflected light may be output to the autonomous bicycle 100. The LIDAR 201a, and the radar 201b are not necessarily provided in an overlapping manner.

For example, external cameras 202 providing imaging of an external situation of the autonomous bicycle 100. The camera 202 is, for example, provided on the frame sections of the autonomous bicycle 100. The camera 202c may be a monocular camera 202a or may be a stereo camera 202b. The stereo camera 202c has, for example, two imaging units that are arranged so as to reproduce a binocular parallax. The image information of the stereo camera 202c also includes information on the depth direction. The camera 202 outputs the image information relating to the external situation to the of the autonomous bicycle 100. In addition, the camera 202 may be an infrared camera 202d or a visible light camera 202e.

For example, GPS 203 receives signals from three or more GPS satellites and acquires position information indicating the position of the autonomous bicycle 100. The latitude and the longitude of the autonomous bicycle 100 may be included in the position information. The GPS 203 receiver 203a outputs the measured position information of the autonomous bicycle 100. Instead of the GPS 203 another means for specifying the latitude and the longitude at which the autonomous bicycle 100 is present may be used.

The map database 203a is a database in which map information is included. The map database 203a is formed, for example, in a hard disk drive (HDD) mounted on the autonomous bicycle 100. In the map information, for example, position information of roads, information on road types, and position information of intersections, and branch points are included. For example, type of a curve or a straight portion and a curvature of the curve are included in the information on the road type.

Furthermore when engaged by the navigation system 205, the autonomous driving 306 adjust position information for simultaneous localization and mapping technology (SLAM), the map information may include an output signal of the external sensors 201, cameras 202 and the GPS map database 203a may be stored in a computer in a facility such as an information processing center which is capable of communicating with autonomous bicycle 100.

For example, the navigation system 205 is a device configured to perform guidance to a destination set on the map by a rider 101 and calculates a travelling route of the autonomous bicycle 100 based on the position information of the autonomous bicycle 100 measured by the GPS 203 uses a receiver and the map information in the map database 203a. The route may be a route on which a travelling lane is specified, in which the autonomous bicycle 100 travels in a multi-lane section.

The navigation system 205 calculates, for example, a target route from the position of the autonomous bicycle 100 to the destination and performs notification to the rider 101 by auxiliary devices 204 like lights 204a, speakers 204b, microphone 204c. The navigation system 205, for example, transmits the target route information of the autonomous bicycle 100.

As other communications between the telematics unit 600 and the smart device 211, 602 are possible for instance, GPS 203 using a receiver 203a and map information 203b if the telematics unit 600 is unable to receive GPS satellite signals or generate GPS coordinates, the telematics unit 600 can query the smart device 211, 602 to obtain GPS coordinates 202c.

For example, the control panel 21 is configured to perform an input and output of the information between the rider 101 of the autonomous bicycle 100, accordingly wherein the control panel 21 includes a display panel 21a for displaying the image information, input operation data and output operation data for the rider to review. For example, the rider 101 may wirelessly link her or his mobile phone, the autonomous bicycle's control unit through wireless communication involving one of Wi-Fi, Bluetooth, or a telematic unit or to provide feedback to the rider via the control panel, and incorporates sensor input for monitoring movement based on the action of the rider whilst riding.

For example, the autonomous bicycle system may utilize a service plan may involve one of renting an autonomous bicycle for delivering a payload to a preselected starting location established to pick-up order, and may provide one or more storage compartments for transporting the delivery payload to a delivery location.

For example, the communication path of autonomous bicycle 100 can include wireless rider interface method of controlling an autonomous bicycle 100, comprising the steps of: storing a software application for remotely controlling an autonomous bicycle 100 with a smartphone 602; establishing a short-range wireless communication link between the smartphone 602 and the autonomous bicycle 100 when the smartphone 602 is at the autonomous bicycle 100; receiving data via the short-range wireless communication link from the autonomous bicycle 100 that is used by the software application to display a menu of telematics service selections at the smartphone 602; receiving a telematics service selection from an autonomous bicycle 100 occupant using the smartphone 602 that is chosen from one of the displayed telematics service selections; and transmitting a command that controls at least one function of the autonomous bicycle 100 based on the received telematics service selection from the smartphone 602 to the autonomous bicycle 100 over the short-range wireless communication link.

The auxiliary components or (A-components 204) are subsystem devices may include a telematics Control Unit (TCU) or (telematics unit 600) may involve: receiving data via the short-range wireless communication link from the telematics unit that is used by the software application to display a menu of telematics service selections on a smartphone having a mobile APP; transmitting a command that controls at least one function of the autonomous bicycle based on the received telematics service selection from the smartphone or provide other indicative instruction.

The autonomous bicycle system 200 accordingly may involve an operation amount acquisition unit providing; an environment recognition unit, a control network plan 208 generation unit, thusly as the above-described operation amount acquisition unit is performed by loading the program stored in the ROM into the RAM and executing the control unit programming, a central processing unit (CPU), read only memory (ROM), random access memory (RAM), and various processes and steps exampled herein.

The operation amount acquisition unit acquires the amount of the steering operation, the acceleration operation and the braking operation by the rider 101 of the autonomous bicycle 100 during the autonomous driving 306 based on the information acquired by the internal sensor 203. The amount of operation is, for example, the steering angle of the steering column 105, the steering torque with respect to the steering column 105, the amount of depression on the throttle controller 7, the amount of depression on the brake controller 8, or the operation force on the brake controller. Alternatively, the amount of operation may be a duration of a state in which the steering angle of the steering column 105, the steering torque with respect to the steering column 105, the amount of depression on the throttle controller, the amount of depression on the brake controller, or the operation force on the brake controller is equal to or greater than a threshold value set in advance. The operation amount acquisition unit may also be configured as an operation amount acquirer.

The environment recognition unit step recognizes the surrounding environment of the autonomous bicycle 100 based on the information acquired by one or more of the external sensor 201-202, the GPS 202, receiver 202a, and the map database 202b. The environment recognition unit step includes an obstacle recognition unit step, a road width recognition unit stepl4, and a facility recognition unit step. The obstacle recognition unit step recognizes the obstacle around the autonomous bicycle 100 as a status of the surrounding environment of the autonomous bicycle 100 based on the information acquired by the external sensors 201. For example, a pedestrian, another vehicle, a moving object such as a common motorcycle or a common bicycle, a lane boundary line (lane line, yellow line), a stationary object such as a curb, a guardrail, a pole, a median strip, a building, or a tree may be included in obstacles recognized by the obstacle recognition unit step. The obstacle recognition unit step acquires information on one or more of a distance between the obstacle and the autonomous bicycle 100, a position of the obstacle, a relative speed of the obstacle with respect to the autonomous bicycle 100, and a type of obstacle. The type of obstacle may be identified as a pedestrian, another vehicle, a moving object or a stationary object. The environment recognition unit step may be configured as an environment recognizer. Furthermore, the obstacle recognition unit step may be configured as an obstacle recognizer.

The road width recognition unit step recognizes a road width of the road on which the autonomous bicycle 100 travels as the surrounding environment of the autonomous bicycle 100 based on the information acquired by one or more of the external sensors.

The control network 300 recognizes whether or not the autonomous bicycle 100 control network plan 208 is a route for traveling on a bicycle lane, on a street, or driving through an intersection or a parking lot as the surrounding environment in which the autonomous bicycle 100 control network plan 208 or riders plan is based on one or more of the map information acquired by the map database and the position information of the autonomous bicycle 100 acquired by the GPS 203. For example, as the surrounding environment of the autonomous bicycle 100 based on the map information and position information of the autonomous bicycle 100, in which the road has potential threats or obstacles.

The generation unit generates a control network plan 208 for the autonomous bicycle 100 based on the information on the target route calculated by the navigation system 205, the information of the obstacle around the autonomous bicycle 100 recognized by the environment recognition unit step, and the map information acquired by the map database. The control network plan 208 is a trajectory of the autonomous bicycle 100 on the target route. For example, a speed, an acceleration, a deceleration, a direction, and a steering angle of the autonomous bicycle 100 may be included in the control network plan 208. The control network plan 208 may involve a generation unit which generates a control network plan 208 such that the autonomous bicycle 100 can travel while satisfying standards such as a safety, regulatory compliance, and driving efficiency on the target route. Furthermore, the control network plan generation unit generates a control network plan 208 for the autonomous bicycle 100 so as to avoid contact with an obstacle based on the situation of the obstacle around the autonomous bicycle 100.

In greater detail FIG. 3A is a chart of the control network 300, accordingly the control network is wirelessly in communication with the autonomous bicycle system 200 and the control unit 209. The control network 300 is configured to control the travelling of the autonomous bicycle 100 based on the control network plan 208 generated by the control network plan generation unit and executed by the navigation system 205 when the rider 101 is not engaged (paying attention) or distracted, or when the autonomous bicycle is unmanned.

The control network 300 receives outputs a control signal corresponding to the control unit 209. In this way, the control network 300 controls the travelling of the autonomous bicycle 100 such that the autonomous driving 306 of the autonomous bicycle 100 can be executed according to the control network plan 208 for driving to a destination 209/210, the destination may apply to a job generated from the control network indicative of the rider's plan 101(RP).

The control network is in control of a navigation switch 303 for switching to manual driving 304 and a navigation switch 305 for switching to autonomous driving 306. In addition, the control network operation or (remote operation 301) is to instruct the control unit 209 by remote interface methodology to provide procedure involving an operation to switch 305 to manual driving 304 calculated by the calculation unit step, the control network 300 via the control unit to switch 305 the autonomous driving 306 back to manual driving 304, switching process examples are detailed in FIG. 3B.

The control network 300 is systematically connected to the autonomous bicycle's electronic components (E-Components) sensors 21-210, the external sensors 201-202, GPS 203, providing data of manual driving 304 and providing data from autonomous driving 306 to the remote operation 301. Systematically via programming a computer of the control network 300 provides a calculation unit processors for calculating the threshold value for switching to manual driving 304 according to the surrounding environment of the autonomous bicycle 100 recognized by the environment recognition unit step. As described below, when the obstacle is recognized by the obstacle recognition unit step of the environment recognition unit step, the calculation unit step may calculate the threshold value for switching to manual driving 304 according to the distance between the obstacle and the autonomous bicycle 100 and the type of obstacle. In addition, when the obstacle is not recognized by the obstacle recognition unit step of the environment recognition unit step, the calculation unit step may calculate the threshold value for switching to manual driving 304 according to one or more of the road width of the road on which the autonomous bicycle 100 travels and a type of facilities such as a parking lot on which the autonomous bicycle 100 travels. As described below, a function describing the threshold value for switching to manual driving 304 corresponding to the surrounding environment of the autonomous bicycle 100 is stored in the autonomous bicycle 100. The calculation unit step may be configured as a calculator.

For example, the autonomous bicycle system comprising a stabilization system which may involve steering actuators, controllers, gyroscope or inertial measurement units for controlling motion and balance of the autonomous bicycle utilized indicative with a rider's plan 101(RP).

For example, the autonomous bicycle's control unit configured to determine the current position of the autonomous bicycle based on the action of the rider whilst riding.

For example, a preferred mobile APP may be configured or the rider to interface with the autonomous bicycle such that the rider can communicate with the autonomous bicycle system or communicate with a control network remotely.

For example various processors providing instruction data, performance data, rider data, or external linked data.

For example the autonomous bicycle system may involve a plan may involve one of renting an autonomous bicycle for delivering a payload to a user-selected starting location established to pick-up order.

For example the control panel providing a virtual readout of real-time performance data pertaining to one or more operations of the electronic components; receive scheduling information corresponding to a location requesting to pick-up delivery order; confirm a user-selected starting location established to pick-up order then, delivery the order to a user-selected destination location; delivering the payload to a user-selected destination location or to a recipient, whereby the payload is stored in a container, basket, saddlebags, or other storage compartment; provide memory configured to store map information including road information and preselected pick-up stops.

In greater detail FIG. 3B, the control unit 209 of the autonomous bicycle 100 executes the autonomous driving 306 of the autonomous bicycle 100 based on the control network plan 208 achieved firstly by a generation unit (S1). In starting the autonomous driving 306, for example, when an ignition of the autonomous bicycle 100 is turned ON, the control unit 209 determines whether autonomous driving 306 can be executed or not based on the surrounding environment of the autonomous bicycle 100 recognized by the external sensor 201-202, GPS 203 and the environment recognition unit step of the autonomous bicycle 100. When it is determined that autonomous driving 306 can be executed, the control unit 209 notifies the rider 101 though the autonomous bicycle 100 of the fact that autonomous driving 306 can be executed. By the rider 101 performing a predetermined input operation to the autonomous bicycle 100, the autonomous driving 306 device 100 starts autonomous driving 306. The operation amount acquisition unit of the autonomous bicycle 100 acquires the amount of any of the steering operation, the acceleration operation and the braking operation by the rider 101 of the autonomous bicycle 100 during the autonomous driving 306 (S2).

The environment recognition unit step recognizes the surrounding environment of the autonomous bicycle 100 (S3). When the obstacle recognition unit step of the environment recognition unit step recognizes an obstacle around the autonomous bicycle 100 as information relating to a status of the surrounding environment of the autonomous bicycle 100 (S4), the calculation unit step calculates the threshold value for switching to manual driving 304 corresponding to the obstacle (S5). The obstacle recognition unit step of the environment recognition unit step may recognize a presence or position, for example, of the obstacle as information relating to the status of the surrounding environment.

Hereinafter, the calculation of the threshold value for switching to manual driving 304 corresponding to the obstacle by the calculation unit step will be described. For example, a function describing the threshold value for switching to manual driving 304 with respect to the distance between the obstacle and the autonomous bicycle 100 is stored in the autonomous bicycle 100. In the example in FIG. 3, when the distance between the obstacle and the autonomous bicycle 100 exceeds a value of 2, the calculation unit step calculates a threshold value for switching to manual driving 304 Th.sub.0 which is a reference of the threshold value for switching to manual driving 304. On the other hand, when the distance between the obstacle and the autonomous bicycle 100 is equal to or less than 2, the calculation unit step calculates a threshold value for switching to manual driving 304 Th.sub.1 which is lower than Th.sub.0. In the above example, the function describing the threshold value for switching to manual driving 304 with respect to the distance between the obstacle and the autonomous bicycle 100 comprises a stepwise function.

In addition, a function describing the threshold value for switching to manual driving 304 with respect to the distance between the obstacle and the autonomous bicycle 100 as illustrated in FIG. 4 may be stored in the autonomous bicycle 100. In the example in FIG. 4, when the distance between the obstacle and the autonomous bicycle 100 exceeds a value of 3, the calculation unit step calculates a threshold value for switching to manual driving 304 Th.sub.0 which is a reference of the threshold value for switching to manual driving 304. When the distance between the obstacle and the autonomous bicycle 100 is equal to or less than 1, the calculation unit step calculates a threshold value for switching to manual driving 304 Th.sub.1 which is lower than Th.sub.0. When the distance between the obstacle and the autonomous bicycle 100 is equal to or lower than 3 and exceeds 1, the calculation unit step calculates a threshold value for switching to manual driving 304 which linearly decreases from the threshold value for switching to manual driving 304 Th.sub.0 at the time when the distance is 3 to the threshold value for switching to manual driving 304 Th.sub.1 at the time when the distance is 1 as the distance between the obstacle and the autonomous bicycle 100 becomes smaller. In the above example, the function describing the threshold value for switching to manual driving 304 with respect to the distance between the obstacle and the autonomous bicycle 100 comprises a linear function. However, a non-linear function may be included in which the rate of decrease from the threshold value for switching to manual driving 304 Th.sub.0 at the time when the distance is 3 to the threshold value for switching to manual driving 304 Th.sub.1 at the time when the distance is 1 increases or decreases as the distance becomes closer to 1 or 3.

As FIG. 3B further examples, when the obstacle recognition unit step does not recognize an obstacle around the autonomous bicycle 100 (S4) and the facility recognition unit step 15 of the environment recognition unit step recognizes that the autonomous bicycle 100 travels on an intersection or parking lot (S6) as information relating to a status of the surrounding environment of the autonomous bicycle 100, the calculation unit step calculates the threshold value for switching to manual driving 304 corresponding to the intersection and the parking lot recognized by the facility recognition unit step (S7). The facility recognition unit step can recognize the fact that, for example, the autonomous bicycle 100 travels on an intersection by detecting a blinking of a traffic signal using the external sensor 201-202 or by the information acquired by the GPS 203. In addition, the facility recognition unit step can recognize the fact that the autonomous bicycle 100 travels on a parking lot by detecting external signs, such as a mark “P”, using the external sensor 201-205 or by the information acquired by the GPS 201A. Respectively, even when the obstacle recognition unit step does not recognize an obstacle around the autonomous bicycle 100 (S4) and the facility recognition unit step of the environment recognition unit step does not recognize that the autonomous bicycle 100 travels on an intersection or a parking lot (S6) as information relating to a status of the surrounding environment of the autonomous bicycle 100, the calculation unit step may calculate the threshold value for switching to manual driving 304 based on the road width recognized by the road width recognition unit step of the environment recognition unit step (S8).

A function describing the threshold value for switching to manual driving 304 with respect to the parking lot scenario for example, the calculation unit step calculates a threshold value for switching to manual driving 304 Th.sub.0 which is a reference of the threshold value for switching to manual driving 304. On the other hand, when the autonomous bicycle 100 travels in the parking lot, the calculation unit step calculates a threshold value for switching to manual driving 304 Th.sub.p which is lower than Th.sub.0.

Alternatively, a function of the threshold value for switching to manual driving 304 with respect to a predetermined time before the autonomous bicycle 100 enters the intersection and at a predetermined time after passing through the intersection, the calculation unit step calculates a threshold value for switching to manual driving 304 Th.sub.0 which is a reference of the threshold value for switching to manual driving 304. When the autonomous bicycle 100 travels in the intersection, the calculation unit step calculates a threshold value for switching to manual driving 304 Th.sub.c which is lower than Th.sub.0.

During the time from a predetermined time before the autonomous bicycle 100 enters the intersection to a time when the autonomous bicycle 100 enters the intersection, the calculation unit step calculates a threshold value for switching to manual driving 304 which linearly decreases from the threshold value for switching to manual driving 304 Th.sub.0 to the threshold value for switching to manual driving 304 Th.sub.c as the autonomous bicycle 100 becomes closer to the intersection. During the time from when the autonomous bicycle 100 passes through the intersection to a time when a predetermined time has elapsed, the calculation unit step calculates a threshold value for switching to manual driving 304 which linearly increases from the threshold value for switching to manual driving 304 Th.sub.c to the threshold value for switching to manual driving 304 Th.sub.0 as the autonomous bicycle 100 moves away from the intersection. In a similar manner, the calculation unit step can calculate a threshold value for switching to manual driving 304 when the autonomous bicycle 100 travels on a school route, near a childcare facility, near a school, and near a park. Although the above examples have been described with respect to a functional relationship between the threshold value for switching to manual driving 304 and time, the relationship may be based on a distance or a positional relationship with respect to the intersection.

A function describing the threshold value for switching to manual driving 304 with respect to the road width when the road width exceeds an ordinary width, the calculation unit step calculates a threshold value for switching to manual driving 304 Th.sub.0 which is the reference of the threshold value for switching to manual driving 304. When the road width is a minimum width in which the autonomous bicycle 100 can travel, the calculation unit step calculates a threshold value for switching to manual driving 304 Th.sub.min which is a minimum value of the threshold value for switching to manual driving 304. When the road width is equal to or less than the ordinary width and exceeds the minimum width, the calculation unit step calculates a threshold value for switching to manual driving 304 which linearly decreases from the threshold value for switching to manual driving 304 Th.sub.0 of the ordinary width to the threshold value for switching to manual driving 304 Th.sub.min of the minimum width as the road width becomes narrower. The calculation unit step may calculate the threshold value for switching to manual driving 304 Th.sub.0 based on a vehicle-width of the autonomous bicycle 100 registered in the autonomous bicycle 100 in advance or a general road width registered in the autonomous bicycle 100 or in the map database 202b in advance.

In addition, a unit of the road width can be a meter [m], and when the amount of operation by the rider 101 relates to the steering operation, a unit of the threshold value for switching to manual driving 304 Th.sub.0 can be a degree which indicates the steering angle.

Accordingly, when the amount of operation is equal to or greater than the threshold value for switching to manual driving 304 (S9), the control unit 209 switches the driving state from autonomous driving 306 to manual driving 304 (S10). On the other hand, when the amount of operation is less than the threshold value for switching to manual driving 304 (S9), the control unit 209 continues to execute the autonomous driving 306.

According to the first embodiment, the threshold value for switching to manual driving 304 which is used for switching the driving state from autonomous driving 306 to manual driving 304 with respect to the amount of operation such as the steering operation by the rider 101 is calculated by the calculation unit step according to the surrounding environment of the autonomous bicycle 100 recognized by the environment recognition unit step. Therefore, the amount of intervention of the driving operation by the rider 101 for switching the driving state from autonomous driving 306 to manual driving 304 conforms to the surrounding environment of the autonomous bicycle 100.

In addition, according to the first embodiment, regardless of the presence or absence of the recognition of an obstacle, as the road width becomes narrower, it becomes easier to switch the driving state from autonomous driving 306 to manual driving 304, and thus, the ease of coping with the case of a narrow road width is improved. In addition, regardless of the presence or absence of the recognition of an obstacle, it becomes easier to switch the driving state from autonomous driving 306 to manual driving 304 when the autonomous bicycle 100 travels on an intersection or a parking lot, and thus, the ease of coping with the case of the intersection or the parking lot is improved.

In addition, the environment recognition unit step may not include all of the obstacle recognition unit step, the road width recognition unit step, and may not execute all of the processing tasks. For example, any one or a plurality of configuration elements among the obstacle recognition unit step the road width recognition unit step may be omitted from the environment recognition unit step. When the road width recognition unit step and the recognition unit step are omitted, the calculation unit step may execute only the processing tasks of S4 and S5. In addition, when the obstacle recognition unit step and the road width recognition unit step are omitted, the calculation unit step may execute only the processing tasks of S6 and S7 after the processing of S3, and may not execute the processing of S8. In addition, when the obstacle recognition unit step and the recognition unit step are omitted from the environment recognition unit step, the calculation unit step may execute only the processing of S8 after the processing of S3, and may not execute the processing tasks of S4 to S7.

In addition, when the road width recognition unit step is omitted from the environment recognition unit step, the calculation unit step may execute only the processing tasks of S6 and S7 when the obstacle is not recognized in the processing of S4, and may not execute the processing of S8. In addition, when the facility recognition unit step is omitted from the environment recognition unit step, the calculation unit step may execute only the processing of S8 when the obstacle is not recognized in the processing step of S4, and may not execute the processing tasks of S6 and S7. In addition, when the obstacle recognition unit step is omitted from the environment recognition unit step, the calculation unit step may execute only the processing tasks of S6 to S8 after the processing of S3, and may not execute the processing tasks of S4 and S5.

Furthermore, when the environment recognition unit step includes the obstacle recognition unit step, the obstacle recognition unit step may recognize any of the distance between the obstacle and the autonomous bicycle 100 and the type of the obstacle, and then, the calculation unit step may calculate the threshold value for switching to manual driving 304 according only to any of the distance between the obstacle and the autonomous bicycle 100 and the type of the obstacle. In addition, when the obstacle recognition unit step recognizes the type of the obstacle and the calculation unit step calculates the threshold value for switching to manual driving 304 according to the type of the obstacle, the obstacle recognition unit step may recognize only any of whether the obstacle is a pedestrian and another vehicle and whether the obstacle is a moving object or a stationary object, and then, the calculation unit step may calculate the threshold value for switching to manual driving 304 according to only any of whether the obstacle is a pedestrian or another vehicle and whether the obstacle is a moving object or a stationary object.

Furthermore, when the environment recognition unit step includes the obstacle recognition unit step, the road width recognition unit stepl4 and the facility recognition unit step the processing tasks shown may be rearranged, such that, for example, the processing S4 may take place at the position of S6, and so on.

In greater detail FIG. 4 and FIG. 5 illustrates a function describing the threshold value for switching to manual driving 304 with respect autonomous driving 306 in which the travelling of the autonomous bicycle 100 is controlled using the control network plan 208 generated by the control network plan 208 and the semi-autonomous driving state in which the travelling of the autonomous bicycle 100 is controlled based on both the control network plan 208 generated by the rider plan 101(RP) in which any of the amount of the navigation system 205 operation controls the acceleration operation and the braking operation by the rider 101 of the autonomous bicycle 100 is reflected in the travelling of the autonomous bicycle 100, based on any of the amount of the steering operation, the acceleration operation and the braking operation by the rider 101 of the autonomous bicycle 100. In this case, when any of the amount of steering operation, the acceleration operation and the braking operation by the rider 101 of the autonomous bicycle 100 during autonomous driving 306 is equal to or greater than a first threshold value, the control unit 209 switches the driving state from autonomous driving 306 to semi-autonomous driving state, and when any of the amount of steering operation, the acceleration operation and the braking operation by the rider 101 of the autonomous bicycle 100 during the semi-autonomous driving state is equal to or greater than a second threshold value which is greater than the first threshold value, the control unit 209 switches the fully autonomous driving 306-to a semi-autonomous driving state-to a manual driving 304. The calculation unit step can calculate the first threshold value and the second threshold value by a method similar to that of calculating the threshold value for switching to manual driving 304 described above.

Furthermore, in FIG. 4 and FIG. 5 a function describing the threshold value for switching to manual driving 304 with respect to the distance between the obstacle and the autonomous bicycle 100 as illustrated in FIG. 4 may be stored in the autonomous bicycle 100. In the example in FIG. 5, when the distance between the obstacle and the autonomous bicycle 100 exceeds a value of 3, the calculation unit step calculates a threshold value for switching to manual driving 304 Th.sub.0 which is the reference of the threshold value for switching to manual driving 304 regardless of the type of the obstacle. In FIG. 5, a unit of the distance can be a meter [m], and when the amount of operation by the rider 101 relates to a steering operation, a unit of the threshold value for switching to manual driving 304 controls the steering angle. The units mentioned above are merely exemplary, and, for example, a unit of a different scale or an index could be used alternatively. Furthermore, particular values are mentioned above, but such values are merely examples of a predetermined value which may be set appropriately.

When the distance between the obstacle and the autonomous bicycle 100 is equal to or less than 3 and exceeds 1 and the obstacle is a stationary object such as a lane line or a guardrail, the calculation unit step calculates a threshold value for switching to manual driving 304 which linearly decreases from the threshold value for switching to manual driving 304 Th.sub.0 at the time when the distance is 3 to the threshold value for switching to manual driving 304 Th.sub.1 at the time when the distance is 1. When the distance between the obstacle and the autonomous bicycle 100 is equal to or less than 3 and exceeds 1 and the obstacle is another vehicle, the calculation unit step calculates a threshold value for switching to manual driving 304 which linearly decreases from the threshold value for switching to manual driving 304 Th.sub.0 at the time when the distance is 3 to the threshold value for switching to manual driving 304 Th.sub.2 which is lower than Th.sub.1 at the time when the distance is 1. When the distance between the obstacle and the autonomous bicycle 100 is equal to or less than 3 and exceeds 1 and the obstacle is a pedestrian, the calculation unit step calculates a threshold value for switching to manual driving 304 which linearly decreases from the threshold value for switching to manual driving 304 Th.sub.0 at the time when the distance is 3 to the threshold value for switching to manual driving 304 Th.sub.3 which is lower than Th.sub.2 at the time when the distance is 1. When the distance between the obstacle and the autonomous bicycle 100 is equal to less than 1, the calculation unit step calculates the threshold value for switching to manual driving 304 Th.sub.1 when the obstacle is a stationary object, calculates the threshold value for switching to manual driving 304 Th.sub.2 when the obstacle is a threat, and calculates the threshold value for switching to manual driving 304 Th.sub.3 when the obstacle is a pedestrian.

That is, when the distance between the obstacle and the autonomous bicycle 100 is equal to or less than 3 and the obstacle is a pedestrian, the calculation unit step calculates a threshold value for switching to manual driving 304 which is lower than the threshold value for switching to manual driving 304 when the obstacle is another vehicle with respect to the same distance between the obstacle and the autonomous bicycle 100 (a first distance). In addition, when the distance between the obstacle and the autonomous bicycle 100 is equal to or less than 3 and the obstacle is a moving object, the calculation unit step calculates a threshold value for switching to manual driving 304 which is lower than the threshold value for switching to manual driving 304 when the obstacle is a stationary object such as a lane line or a guardrail with respect to the same distance between the obstacle and the autonomous bicycle 100 (a second distance).

In greater detail FIG. 6 there is shown a telematic unit 600 operating environment of an autonomous bicycle 100, the telematics units works as communications system linking the rider to the autonomous bicycle system 200 with her or his smartphone 602 or (smartphone interface) the rider uses a visual display 603 to access features provided by one or more wireless carrier systems 604 associated with any number of different systems that can link to the autonomous bicycle system 200 and to the control network 300 by an onboard control panel 21 linked with external and auxiliary smart devices 211 or to a handheld wireless device such as the rider's smartphone 602 or wearable smart devices like a smart helmet having a virtual display to communicate with the systems 200-300 through the telematics unit 600 via a wireless communication link 605.

It should be understood that the disclosed telematics unit 600 method is not specifically limited to the operating environment shown here. Also, the architecture, construction, setup, and operation of individual components are generally known in the art. Thus, the following paragraphs simply provide a brief overview of one such exemplary system however, other systems not shown here could employ the disclosed method as well.

The smart devices 211 connect to the control panel 21 and the smartphone 602 can carry out communication and control features of the telematics unit 600 when using a software application stored at the control panel 21. While some autonomous bicycles 100 carry telematics units that can monitor autonomous bicycle 100 functions and wirelessly communicate data over a wireless communication link 605. For instance, some autonomous bicycles 100 that carry telematics units 600 may include a visual display that is capable of showing only one line of text at a time. At the same time, the telematics unit 600 may include speech recognition capabilities that allow the rider 101 to recite verbal queries that may benefit from responses shown on additional display space. Smartphones often include a display screen 603 that is capable of showing graphical images and speakers or audio outputs that can audibly play sound. Additionally, or the control panel 21 linked to rider's smartphone 602 can communicate using short-range wireless communication by Bluetooth 606 protocols, cellular communications over a wireless carrier system 603. Sensor data can be received by the smart devices 211 data, or by a smartphone 602 data from the telematics unit 600 is stored in Cloud 607.

One of the networked devices that can communicate with the telematics unit 600 is a smart device 211, 602. The smart device 211, 602 can include computer processing capability, a transceiver capable of communicating using a short-range wireless protocol, and a visual smart device display. In some implementations, the control panel 21 also includes a touch-screen graphical user interface and/or a GPS capable of receiving GPS satellite signals 608 and generating GPS coordinates based on those signals. Examples of the smart devices may include the iPhone™ manufactured by Apple, Inc. and the Android™ manufactured by Motorola, Inc. While the smart devices may also include the ability to communicate via cellular communications using the wireless carrier system, this is not always the case. For instance, Apple manufactures devices such as the iPad™, iPad, and the iPod Touch™ that include the processing capability, the display 603, and the ability to communicate over a wireless communication link 605. However, the iPod Touch and some iPads do not have cellular communication capabilities. Even so, these and other similar devices may be used or considered a type of smart device 211, 602 for the purposes of the method described herein.

When a rider 101 carries a control panel 21 or rider's smartphone 602, the telematics unit 600 can then use the display 603 of that smart devices to show the rider 101 more detailed information, such as a menu containing a plurality of telematics service selections or geographical maps used to provide turn-by-turn directions. In this case, the telematics unit 600 may no longer be limited by a single-line textual display installed on the autonomous bicycle 100 but can display more detailed information using the control panel 21 or rider's smartphone 602. The smart device 211, 602 can also receive commands from the rider 101 and transmit the more detailed information to the telematics unit in response to those commands. In another example, the telematics unit 600 can also determine that the smart device 211, 602 is capable of greater wireless data communication speeds than can be achieved by the telematics unit. As a result, the telematics unit 600 can leverage the wireless communication capability of the smart device 211, 602 to transmit and receive data via the smart device 211, 602 over a cellular wireless communication system by transferring data between the telematics unit and the smart device 211, 602 over the wireless communication link 605. In short, the combination of the display and control features of the smart device 211, 602 can be integrated with the communication, autonomous bicycle 100 monitoring, and information generation capabilities of telematics unit.

Some of the autonomous bicycle 100 electronics is shown generally in FIG. 1 and includes a control panel 21 containing the telematics unit system configured with a microphone and an audio system. Some of these devices can be connected directly or indirectly connected using one or more network connections via a communications bus 609 for example, suitable network connections may include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

According to one embodiment, the telematics unit 600 can be an OEM-installed (embedded) or aftermarket device that enables wireless voice and/or data communication over wireless carrier system and via wireless networking so that the autonomous bicycle 100 can communicate with call center, other telematics-enabled autonomous bicycle 100, or some other entity or device. The telematics unit preferably uses radio transmissions to establish a communications channel (a voice channel and/or a data channel) with wireless carrier system so that voice and/or data transmissions can be sent and received over the channel. By providing both voice and data communication, telematics unit 600 enables the autonomous bicycle 100 to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center) and data communication (e.g., to provide GPS location data or autonomous bicycle 100 diagnostic data to the call center), the system can utilize a single call over a voice channel and switch as needed between voice and data transmission over the voice channel, and this can be done using techniques known to those skilled in the art.

According to one embodiment, the telematics unit 600 utilizes cellular communication according to either GSM or CDMA standards and thus includes a standard cellular chipset for voice communications like hands-free calling, a wireless modem for data transmission, an electronic processing device, one or more digital memory Cloud 607, and a dual antenna. It should be appreciated that the modem can either be implemented through software that is stored in the telematics unit and is executed by processors, or it can be a separate hardware component located internal or external to telematics unit 600. The modem can operate using any number of different standards or protocols such as EVDO, CDMA, GPRS, and EDGE. Wireless networking between the autonomous bicycle 100 and other networked devices can also be carried out using telematics unit 600. For this purpose, telematics unit 600 can be configured to communicate wirelessly according to one or more wireless protocols, such as any of the IEEE 602.11 protocols, WiMAX, or Bluetooth 606. When used for packet-switched data communication such as TCP/IP, the telematics unit can be configured with a static IP address or can set up to automatically receive an assigned IP address from another device on the network such as a router or from a network address server.

According to one embodiment, the processors of the smartphone 602 can be any type of device capable of processing electronic instructions including microprocessors, microcontrollers, host processors, controllers, autonomous bicycle 100 communication processors, and application specific integrated circuits (ASICs). It can be a dedicated processor used only for telematics unit 600 or can be shared with other autonomous bicycle 100 systems. The one or processors executes various types of digitally-stored instructions, such as software or firmware programs stored in memory or Cloud 607, which enable the telematics unit to provide a wide variety of services. For instance, a number of processors can execute programs or process data to carry out at least a part of the method discussed herein.

According to one embodiment, the telematics unit 600 can be used to provide a diverse range of autonomous bicycle 100 services that involve wireless communication to and/or from the autonomous bicycle 100. Such services include: turn-by-turn directions and other navigation-related services that are provided in conjunction with the GPS-based autonomous bicycle 100 navigation module; 991 notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 600, but are simply an enumeration of some of the services that the telematics unit is capable of offering. Furthermore, it should be understood that at least some of the aforementioned modules could be implemented in the form of software instructions saved internal or external to telematics unit 600, they could be hardware components located internal or external to telematics unit 600, or they could be integrated and/or shared with each other or with other systems located throughout the autonomous bicycle 100, to cite but a few possibilities could utilize a method or bus 609 to exchange data and commands with the telematics unit.

For instance the GPS 201A receives radio signals from a constellation of GPS satellites. From these signals, the GPS 203 can determine autonomous bicycle 100 position that is used for providing navigation and other position-related services to the autonomous bicycle 100 driver. Navigation information can be presented on the display or can be presented verbally such as is done when supplying turn-by-turn navigation. The navigation services can be provided using a dedicated in-autonomous bicycle 100 navigation module (which can be part of GPS), or some or all navigation services can be done via telematics unit 600, wherein the position information is sent to a remote location for purposes of providing the autonomous bicycle 100 with navigation maps, map annotations (points of interest, restaurants, etc.), route calculations, and the like. The position information can be supplied to call center or other remote computer system, such as computer, for other purposes, such as fleet management. Also, new or updated map data can be downloaded to the GPS 203 from the call center via the telematics unit 600.

According to one embodiment, the electrical system elements 200-300 also include a number of autonomous bicycle 100 user interfaces that provide rider 101 with a means of providing and/or receiving information, including microphone, audio system connected to the control panel's virtual display for rider plan 101(RP). Various operator interfaces can also be utilized, as the rider 101 interface detailed of FIG. 2, FIG. 3A, FIG. 3B which are only an example of one particular implementation related to the control network 300.

As used herein, the term ‘autonomous bicycle 100 user interface’ broadly includes any suitable form of electronic device, including both hardware and software components, which is located on the autonomous bicycle 100 and enables an autonomous bicycle 100 user to communicate with or through a component of the autonomous bicycle 100. Microphone provides audio input to the telematics unit to enable the driver or other rider 101 to provide voice commands and carry out hands-free calling via the wireless carrier system 606. For this purpose, it can be connected to an on-board automated voice processing unit utilizing human-machine interface (HMI) technology known in the art. The virtual display 603 allows manual user input into the telematics unit 600 to initiate wireless telephone calls and provide other data, response, or control input. Separate pushbuttons can be used for initiating emergency calls versus regular service assistance calls to the call center. Audio system provides audio output to a rider 101 and can be a dedicated, stand-alone system or part of the primary autonomous bicycle 100 provided by speakers of the control panel 21 on the AB 100. According to the particular embodiment shown here, audio system is operatively coupled to both bus 614 and entertainment bus 615 and can provide AM, FM and satellite radio, and other multimedia functionality associated with the speakers and the microphone system. This functionality can be provided in conjunction with or independent of the infotainment module described above. Visual display is preferably a graphics display 603, such as a touch screen on the instrument panel or a heads-up display reflected off of the windshield, and can be used to provide a multitude of input and output functions.

According to one embodiment, the wireless carrier system 606 is preferably a cellular telephone system that includes networking components required to connect wireless carrier system with land network. Each cell tower includes sending and receiving antennas and a base station, with the base stations from different cell towers being connected to the MSC either directly or via intermediary equipment such as a base station operator. Cellular system can implement any suitable communications technology, including for example, analog technologies such as AMPS, or the newer digital technologies such as CDMA (e.g., CDMA8000) or GSM/GPRS. As will be appreciated by those skilled in the art, various cell tower/base station/MSC arrangements are possible and could be used with wireless system. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system, a different wireless carrier system in the form of satellite communication can be used to provide uni-directional or bi-directional communication with the autonomous bicycle 100. This can be done using one or more communication satellites and an uplink transmitting station. Uni-directional communication can be, for example, satellite radio services, wherein programming content (news, music, etc.) is received by transmitting station, packaged for upload, and then sent to the satellite, which broadcasts the programming to subscribers. Bi-directional communication can be, for example, satellite telephony services using satellite 605 to relay telephone communications between the autonomous bicycle 100 and the control network 300. If used, this satellite telephony can be utilized either in addition to or in lieu of wireless carrier system.

According to one embodiment, the land network may be a conventional land-based telecommunications network that is connected to one or more landline telephones and connects wireless carrier system 606 to a call center. For example, land network 16 may include a public switched telephone network (PSTN) such as that used to provide hardwired telephony, packet-switched data communications, and the Internet infrastructure. One or more segments of land network could be implemented through the use of a standard wired network, a fiber or other optical network, a cable network, power lines, other wireless networks such as wireless local area networks (WLANs), or networks providing broadband wireless access (BWA), or any combination thereof. Furthermore, the call center need not be connected via land network 16, but could include wireless telephony equipment so that it can communicate directly with a wireless network, such as wireless carrier system.

According to one embodiment, the computer can be one of a number of computers accessible via a private or public network such as the Internet. Each such computer can be used for one or more purposes, such as a web server accessible by the autonomous bicycle 100 via telematics unit 600 and wireless carrier. Other such accessible computer can be, for example: a service center computer where diagnostic information and other autonomous bicycle 100 data can be uploaded from the autonomous bicycle 100 via the telematics unit 600; a client computer used by the autonomous bicycle 100 owner or other subscriber for such purposes as accessing or receiving autonomous bicycle 100 data or to setting up or configuring subscriber preferences or controlling autonomous bicycle 100 functions; or a third party repository to or from which autonomous bicycle 100 data or other information is provided, whether by communicating with the autonomous bicycle 100 or call center, or both. A computer can also be used for providing Internet connectivity such as DNS services or as a network address server that uses DHCP or other suitable protocol to assign an IP address to the autonomous bicycle 100.

According to one embodiment, the call center is designed to provide the autonomous bicycle 100 electronics with a number of different system back-end functions and, according to the exemplary embodiment shown here, generally includes one or more switches servers, databases, live advisors, as well as an automated voice response system (VRS), all of which are known in the art. These various call center components are preferably coupled to one another via a wired or wireless local area network switch, which can be a private branch exchange (PBX) switch, routes incoming signals so that voice transmissions are usually sent to either the live adviser by regular phone or to the automated voice response system using VoIP. The live advisor phone can also use VoIP as indicated by the broken line, VoIP and other data communication through the switch is implemented via a modem (not shown) connected between the switch and network. Data transmissions are passed via the modem to server and/or database. Database can store account information such as subscriber authentication information, autonomous bicycle 100 identifiers, profile records, behavioral patterns, and other pertinent subscriber information. Data transmissions may also be conducted by wireless systems, such as 602.11x, GPRS, and the like. Although the illustrated embodiment has been described as it would be used in conjunction with a manned call center using live advisor, it will be appreciated that the call center can instead utilize VRS 88 as an automated advisor or, a combination of VRS 88 and the live advisor can be used.

As shown in FIG. 6 a charted method of controlling a telematics unit 600 is exampled within the lined area. The method 600 begins at step 610 by storing software. The software can be an application that controls autonomous bicycle 100 functions. The software can then be operated using the processing capabilities of the smartphone 602.

At step 620, the method detects the presence of the smart device 211, 602 that includes software capable of remotely controlling the telematics unit 600 via the wireless communication link 605 between the telematics unit 600 and the smart device 211, 602. The wireless communication link 605 can be established using any one of the short-range communication protocols discussed above. The method 800 can be described using the Bluetooth 606 protocol. The wireless communication link 605 can be established by pairing the smart device 211, 602 with the telematics unit 600. A query can be sent from the telematics unit 600 to the smart device 211, 602 that asks whether software for controlling the telematics unit 600 is installed or saved at the smart device 211, 602. If the telematics unit 600 receives a reply over the wireless communication link 605 confirming the existence of such software, the telematics unit 600 and the smart device 211, 602 can begin to communicate. The method 600 proceeds to step 630.

At step 630, the stored software communicatively connects the smart device 211, 602 with the telematics unit 600 via the wireless communication link 605. Once paired, the telematics unit 600 and/or the smart device 211, 602 can direct the software to communicate using the indicative protocol based on the Bluetooth 606 short-range wireless connections and exchange data, such as commands from the smart device 211, 602 to the telematics unit 600. The indicative protocol can wirelessly emulate serial cable line settings and the status of a serial port and can be used for the transfer of serial data. In this case, the telematics unit 600 can directly connect with the smart device 211, 602 using the indicative protocol and the pairing of the telematics unit 600 and the smart device 211, 602 can be carried out based on the indicative protocol. Over the wireless communication link-using the indicative protocol or otherwise-the telematics unit 600 can be controlled via commands that are represented by codes. In one example, these codes can be provided by a user interface table (UIT) that includes a number for each action. The UIT can be stored at the telematics unit 600 and the smart device 211, 602. That way, the UIT number can be sent over the short-range wireless communication protocol to the telematics unit 600 or the smart device 211, 602 and that number can be interpreted and translated into the appropriate command. The method 600 proceeds to step 640.

At step 640, autonomous bicycle 100 data for generating a telematics service menu offering telematics service commands 606 on the smart device 211, 602 display 603 of the smart device 211, 602 is transmitted from the telematics unit 600 to the smart device 211, 602 via the wireless communication link 605 and the selection of one of the telematics service commands made by a rider 101 is received. Vehicle data can generally relate to the operation of the autonomous bicycle 100. Examples of autonomous bicycle 100 data include turn-by-turn directions, diagnostic trouble codes (DTCs), and messages received from the call center. Telematics service selections that represent commands can be chosen at the smart device 211, 602 from one of the telematics service selections displayed on the smart device 211, 602 and received in response to autonomous bicycle 100 data that is displayed at the smart device 211, 602. The telematics unit 600 can provide not only autonomous bicycle 100 data but also computer-readable information that the smart device 211, 602 can use to display a menu of telematics service selections. This computer-readable information can establish any one or more variables, such as the number of telematics service options presented to the rider 101, static data shown on the smart device 211, 602 display 603, the font of the characters displayed, the color of the smart device 211, 602 display 603, and more. In short, the computer-readable information can control the overall appearance of the information shown on the smart device 211, 602 display 603.

According to one embodiment, the telematics service menu used at the smart device 211, 602 can also provide master-slave status to the user of the telematics service menu via the smart device 211, 602. That is, even though the telematics unit 600 can receive selections from devices mounted on the autonomous bicycle 100, such as virtual prompts, the telematics service menu use at the smart device 211, 602 may be encoded to override selections made from inputs other than those displayed on the smart device 211, 602. Thus, the smart device 211, 602 menu becomes the master control, while the other inputs are subordinate to the smart device 211, 602 menu. The method 640 proceeds to step 650.

At step 650, the selected telematics service command is transmitted to the telematics unit 600 via the wireless communication link 605 and one or more autonomous bicycle 100 functions are controlled using the telematics unit 600 based on the transmitted telematics service command. This selected command can control at least one function of the autonomous bicycle 100. Using the menu shown on the smart device 211, 602 display 603, the rider 101 can select an option, such as by manually pressing the smart device 211, 602 display 603 where a button representing a selection is shown. In one example, the telematics unit 600 can determine the rider 101 is experiencing some type of emergency, such as an autonomous bicycle 100 accident. This can be determined when the telematics unit 600 receives a signal from the rider 101 via 911 that, in this example, can detect the occurrence of an autonomous bicycle 100 accident. In response, the telematics unit 600 can generate a telematics service menu to send the smart device 211, 602 via the wireless communication link 605. Each of these selections can be made using the smart device 211, 602 and being sent to the telematics unit 600 over the short-range wireless link is possible.

In another example, the rider 101 using the smart device 211, 602 can request turn-by-turn directions from one location to another location. The user or rider 101 can verbally request these directions using the speech recognition function of the telematics unit 600. In response, the telematics unit 600 can generate information to create a menu that includes a keypad for selecting address numbers and/or address alphabet characters for the rider 101 to select. This information can be transmitted via the wireless communication link 605 to the smart device 211, 602 where the menu can be generated and shown on the smart device 211, 602 display 603. The rider 101 can then select the appropriate numbers and alphabet characters shown on the smart device 211, 602 display 603 thereby sending commands representing these selections to the telematics unit 600 over the short-range wireless link. These commands can be sent to the telematics unit 600 using the indicative protocol described above. The telematics unit 600 can transmit the present location of the autonomous bicycle 100 and the destination address entered using the smart device 211, 602 to the call center, which can return the turn-by-turn directions to the telematics unit 600. While the turn-by-turn directions can be audibly played in the autonomous bicycle 100 using the audio system 36, the telematics unit 600 can also send a geographical map to the smart device 211, 602 over the wireless communication link 605 to be displayed on the smart device 211, 602 display 603. The menu shown on the smart device 211, 602 display 603 and used to select the address can then be replaced with an image of the geographical map. This map can include icons, such as an icon representing the destination on the map and an icon representing the autonomous bicycle 100 as it moves along the map. The position of the autonomous bicycle 100 icon on the map can be updated using GPS coordinates generated by the GPS 201A located on the autonomous bicycle 100.

Other communications between the telematics unit 600 and the smartphone has a mobile APP 650. For instance, the mobile APP 650 provides GPS mapping where information is received through GPS satellite signals, or generate GPS coordinates, to send GPS coordinates and use those received GPS coordinates in the execution and/or presentation of the turn-by-turn directions to drive the autonomous bicycle 100. In another example, the call center can send messages relating to autonomous bicycle 100 operation. These messages can be sent from the smartphone via the mobile APP 650. Accordingly, the mobile APP is designed with autonomous navigation software for monitoring, communicating or managing operations of the autonomous bicycle 100 via rider interface 101(I). The method 650 then ends.

Other communications in which the telematics unit of an autonomous bicycle may involve transmitting a command that controls at least one function of the autonomous bicycle based on the received telematics service selection from the smartphone or provide other relevant commands related to autonomous control network plans.

Other communications in which the telematics unit of an autonomous bicycle may involve the control network involving controlling a current position of the autonomous bicycle based on receiving information corresponding to at least one rider-selected starting location and a rider-selected destination location.

Other communications may involve the control network involving determining GPS routes for an available autonomous bicycle to pick-up a rider based on the scheduling information and to drop-off rider at a location determined by GPS.

Other communications may involve the control network involving one of: renting an autonomous bicycles to transport riders or renting an autonomous bicycle for picking up a delivery payload; identify available autonomous bicycles to transport passengers, determine routes for the available autonomous bicycles to travel, the routes including delivery stops and being determined based on the scheduling information; receiving information corresponding to at least one virtual operator-selected starting location and a destination location.

Other communications may involve the control network virtually controlling one of: execute autonomous driving operation carried out during a driving state of an autonomous bicycle; execute a manual driving operation carried out during a driving state of the autonomous bicycle; switching the driving state from autonomous driving to manual driving when the value indicative of the degree to which the operation is carried out is equal to or greater than the threshold value for switching to manual driving; calculate the threshold value for switching to manual driving according to the status of the surrounding environment recognized by the environment recognizer, wherein the environment recognizer is configured to recognize an obstacle around the autonomous bicycle as information relating to the status of the surrounding environment the status being a threat or an obstacle; calculate the threshold value for switching to manual driving which becomes lower when a distance between the obstacle and the autonomous bicycle becomes smaller.

Other communications may involve the control network which may a processor for one of the following actions: determine GPS routes for an available autonomous bicycle to pick-up a rider based on the scheduling information then, to drop-off rider at a location determined by GPS routes; or determine the GPS routes by determining at least one route that includes the specific pickup location and the specific drop-off location corresponding to the premium travel request; or generate a GPS route for the autonomous bicycle or to predict a route based on prior routes taken by the autonomous bicycle.

Other communications in which the control network plan for renting an autonomous bicycle may involve one of: receive scheduling information corresponding to at least one travel request and including a user-selected starting location and a user-selected destination location; provide memory configured to store map information including road information and preselected pick-up stops; receive information corresponding to at least one virtual operator-selected starting location and a destination location, and a processor coupled to the network access device configured to store information virtually; receive public transportation schedules, or the memory is further configured to store the public transportation schedules, to transmit the identified regions to corresponding autonomous bicycles that are available nearest to the pick-up stop; receive traffic data corresponding to vehicle traffic or human traffic at various locations; identify the routes for the available autonomous bicycles to travel based on the public transportation schedules.

Other communications in which the control network plan may involve one of: receive scheduling information corresponding to a location requesting to pick-up delivery order; confirm a user-selected starting location established to pick-up order then, delivery the order to a user-selected destination location; delivering the payload to a user-selected destination location or to a recipient, whereby the payload is stored in a container, basket, saddlebags, or other storage compartment; provide memory configured to store map information including road information and preselected pick-up stops.

Other communications in which the control network plan may involve one of renting an autonomous bicycle for delivering a payload to a user-selected starting location established to pick-up order.

As used in this specification and claims, the terms “mobile APP,” “vehicle,” “controller,” “electronic motor,” “actuator,” “electronic components,” “autonomous components,” “signals,” “for example,” “for instance,” “such as,” “like,” “comprising,” “having,” “including,” and other language forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

It is to be understood that the foregoing is a description of one or more preferred exemplary embodiments of the invention. The invention is not limited to the particular embodiments disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiments will become apparent to those skilled in the art. All such other embodiments, changes, and modifications are intended to come within the scope of the appended claims.

I claim:

1. An autonomous bicycle system comprising:
an autonomous bicycle having a frame which may include one or more of the following: front and rear wheels, a seat, a steering column configured with a steering actuator connecting to a front wheel, a throttle controller, a brake controller, an automated pedal assistance system including a set of pedals and an electronic motor, electronic motors, actuators, motor controllers, internal sensors, a control panel, compartments, a control unit, external sensors and cameras to determine if a rider is onboard or is not onboard, and a battery system to provide power to system components;
rider interface for executing an operation plan for manual driving which may involve a smartphone connection provided for remote instruction.

2. The autonomous bicycle system of claim 1 in which the rider interface for executing an operation plan for manual driving may involve one of:
steering with a handlebar;
a control panel connected on the steering column in view of the rider;
utilizing a throttle controller for manually controlling steering direction;
utilizing a brake controller for manually controlling speed;
accessing performance data gathered from sensors through a control panel providing with a virtual display for a rider input/output;
using a smartphone for remote instruction;
planning a GPS route.

3. The autonomous bicycle system of claim 1 in which an operation plan may involve:
autonomous driving utilizing a navigation system associated with a steering system linked to keep the autonomous bicycle upright when the autonomous bicycle is manned or unmanned;
a stabilization system linked to the internal sensors for controlling motion, position, and balance to keep the autonomous bicycle upright
a control unit provided to implement autonomous driving in real-time when activated by a rider of the autonomous bicycle.

4. An autonomous bicycle system comprising:
an autonomous bicycle including a handle bar having a throttle controller connecting to an electronic motor of a front wheel;
a brake controller via the control unit connecting to a braking device connecting to at least a front wheel or a rear wheel;
a common kickstand manually activated when no movement occurs;
a set of pedals which are pedaled by the rider, and/or the rider engages an automated pedal assistance system to provide additional torque to turn at least one rear wheel thereby providing faster pedaling speed;
a stabilization system which may involve steering actuators, motor controllers, gyroscope or inertial measurement units for controlling motion and balance of the autonomous bicycle when manned;
a combination of sensors and cameras to detect a threat, obstacle, mechanical motion, or to provide feedback and sensor input to the rider in real time, the sensor input based on a current motion or a current position of the autonomous bicycle;
a control panel set in view of the rider, a virtual display for rider interface, a selection menu for accessing communication components which may include speakers, a microphone, Internet, Bluetooth associating with internal or external auxiliary components which may include smart devices, or a smartphone providing rider interface according to a rider plan.

5. The autonomous bicycle system of claim 1 and claim 4 in which the rider's plan may involve one of:
use a preferred mobile APP configured or the rider to interface with the autonomous bicycle such that the rider can communicate with the autonomous bicycle system or communicate with a control network remotely;
wherein the control panel providing a virtual readout of real-time performance data pertaining to one or more operations of the electronic components;
various processors providing instruction data, performance data, rider data, or external linked data;
wherein the rider may wirelessly link her or his smartphone, the autonomous bicycle's control unit through wireless communication involving one of Wi-Fi, Bluetooth, or a telematic unit;
generating a GPS route of a current position of the autonomous bicycle based on receiving information corresponding to at least one rider-selected starting location and a rider-selected destination location.

6. An autonomous bicycle system comprising:
vehicle framework characterized as one of: bicycles, tricycles, motorcycles, mopeds, and go-carts utilizing peddling power that turns a rear wheel or using a motorized chain or belt driven system that turns a rear wheel, or using a combination thereof
wherein the vehicle framework may include:
a control panel providing WIFI, Bluetooth and non-transitory computer readable medium having computer readable instructions executed by processor connected to an autonomous control system and
a combination of sensors and cameras to determining a threat, obstacle, or mechanical motion;
a control network link providing autonomous navigation instruction associated with controlling steering, velocity and position of an autonomous bicycle based on the service plan, wherein the control network link to provide feedback and sensor input to a virtual operator in real time, or sensor input based on a current motion or a current position of the autonomous bicycle;
a navigation system for providing a control network plan generating a GPS route of a current position of the autonomous bicycle based on at least one rider-selected starting location and destination location;
a stabilization system having gyro or IMU sensors;
an electro-mechanical kickstand providing balance support of autonomous bicycle when in motion or when stationary;
a smartphone connected therein providing Internet, WIFI and Bluetooth configured to wirelessly link a rider to the autonomous control system, the smartphone APP systematically linking to the autonomous control system and configured to receive rider input in accordance with linked information received from sensor data to manually navigate the autonomous bicycle to selected geographic areas, accordingly the smartphone utilizing an APP further comprising an operation start key associated with an identification code of a rider allows use of the autonomous bicycle for various rider plans, control network plans, or service plans;
the control panel provides rider interface via a virtual a touch screen configured with a menu of control settings, performance status of autonomous bicycle then storing performance data to memory in Cloud.

7. The autonomous bicycle system of claim 1, claim 6 in which the stabilization system which may involve steering actuators, controllers, gyroscope or inertial measurement units for controlling motion and balance of the autonomous bicycle when manned or when unmanned.

8. The autonomous bicycle system of claim 6 in which the electro-mechanical kickstand providing at least one of: an electro-mechanical kickstand autonomously activated by the control unit to maintain an upright position during autonomous driving;
maintaining vertical axis of a front wheel and/or a wheel with respect to keeping the autonomous bicycle upright;
an electro-mechanical kickstand configured with actuating motors to raise and lower during manual driving;
an electro-mechanical kickstand configured with dummy rear wheels provided for added balance support during autonomous driving;
the electro-mechanical kickstand with dummy wheels may set at ground level when the autonomous bicycle is unmanned such that balance is upheld when traveling or when no movement occurs.

9. The autonomous bicycle system of claim 1, claim 4 in which the rider plan may involve driving manually with no assistance from a navigation system.

10. The autonomous bicycle system of claim 1, claim 4, claim 6 in which the rider plan may involve assistance from the navigation system to switch to autonomous driving.

11. The autonomous bicycle system of claim 6 in which the autonomous bicycle is configured for accomplishing at least one function involving a rider plan, a control network plan, a service plan or a combination thereof.

12. The autonomous bicycle system of claim 1 and claim 6 in which the control network involving controlling a current position of the autonomous bicycle based on at least one rider-selected starting location and a rider-selected destination location.

13. The autonomous bicycle system of claim 6 in which the control network involving determining GPS routes for an available autonomous bicycle to pick-up a rider based on the scheduling information and to drop-off the rider at a location determined by GPS.

14. The autonomous bicycle system of claim 6 in which the control network involving one of:
renting an autonomous bicycles to transport riders or renting an autonomous bicycle for picking up a delivery payload;
identify available autonomous bicycles to transport passengers, determine routes for the available autonomous bicycles to travel, the routes including delivery stops and being determined based on the scheduling information;
receiving information corresponding to at least one virtual operator-selected starting location and a destination location.

15. The autonomous bicycle system of claim 6 in which the control network virtually controlling one of:
execute autonomous driving operation carried out during a driving state of an autonomous bicycle;
execute a manual driving operation carried out during a driving state of the autonomous bicycle;
switching the driving state from autonomous driving to manual driving when the value indicative of the degree to which the operation is carried out is equal to or greater than the threshold value for switching to manual driving;
calculate the threshold value for switching to manual driving according to the status of the surrounding environment recognized by the environment recognizer, wherein the environment recognizer is configured to recognize an obstacle around the autonomous bicycle as information relating to the status of the surrounding environment the status being a threat or an obstacle;
calculate the threshold value for switching to manual driving which becomes lower when a distance between the obstacle and the autonomous bicycle becomes smaller.

16. The autonomous bicycle system of claim 6 in which the control network which may a processor for one of the following actions:
determine GPS routes for an available autonomous bicycle to pick-up a rider based on the scheduling information then, to drop-off rider at a location determined by GPS routes; or
determine the GPS routes by determining at least one route that includes the specific pickup location and the specific drop-off location corresponding to the premium travel request; or generate a GPS route for the autonomous bicycle or to predict a route based on prior routes taken by the autonomous bicycle.

17. The autonomous bicycle system of claim 6 in which a plan for renting an autonomous bicycle may involve one of:
receive scheduling information corresponding to at least one travel request and including a user-selected starting location and a user-selected destination location;
provide memory configured to store map information including road information and preselected pick-up stops;
receive information corresponding to at least one virtual operator-selected starting location and a destination location, and a processor coupled to the network access device configured to store information virtually;
receive public transportation schedules, or the memory is further configured to store the public transportation schedules, to transmit the identified regions to corresponding autonomous bicycles that are available nearest to the pick-up stop;
receive traffic data corresponding to vehicle traffic or human traffic at various locations;
identify the routes for the available autonomous bicycles to travel based on the public transportation schedules.

18. The autonomous bicycle system of claim 6 in which a plan may involve one of:
receive scheduling information corresponding to a location requesting to pick-up delivery order;
confirm a user-selected starting location established to pick-up order then, delivery the order to a user-selected destination location;
delivering the payload to a user-selected destination location or to a recipient, whereby the payload is stored in at least one storage compartment;
provide memory configured to store map information including road information and preselected pick-up stops.

19. The autonomous bicycle system of claim 6 in which a service plan may involve one of renting an autonomous bicycle for delivering a payload to a preselected starting location established to pick-up order, and may provide one or more storage compartments for transporting the delivery payload to a delivery location.

20. The autonomous bicycle system of claim 1 and claim 6 in which the control network configured to execute autonomous driving of an autonomous bicycle by switching a driving state from autonomous driving to manual driving or vice versa indicative of various rider plans, control network plans, service plans or a combination thereof.
